(19) United States
(12) Patent Application Publication
(10) Pub. No.: US 2014/0043255 A1
(43) Pub. Date: Feb. 13, 2014

(54) ELECTRONIC DEVICE AND IMAGE ZOOMING METHOD THEREOF

(71) Applicants: HONG FU JIN PRECISION INDUSTRY (ShenZhen) CO., LTD., (US); HON HAI PRECISION INDUSTRY CO., LTD., New Taipei (TW)

(72) Inventors: TE-JIA LIU, Shenzhen (CN); CHIH-SAN CHIANG, New Taipei (TW); HAI-SEN LIANG, Shenzhen (CN); HUA-DONG CHENG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/783,414

(22) Filed: Mar. 4, 2013

(30) Foreign Application Priority Data
Aug. 9, 2012 (CN) 201210281930X

(51) Int. Cl. G06F 3/0488

(52) U.S. Cl. CPC G06F 3/0488
USPC 345/173

(57) ABSTRACT

A page zooming method for an electronic device having a touch screen includes the following steps. Display an image on the touch screen. Generate operation signals in response to a user's touch operation applied on the touch screen when the touch screen displays the image. Determine a touch region of the touch operation, so as to determine the touch operation as a type of an image zooming gesture according to the determined touch region, and the type of the image zooming gesture is selected from a group consisting of a zooming in gesture and a zooming out gesture. Create a zoomed image according to the displayed image, a predetermined zooming ratio and the determined type of the image zooming gesture. And display the zoomed image on the touch screen. An electronic device using the image zooming method is also provided.

### BACKGROUND

1. Technical Field

The present disclosure relates to electronic devices and image zooming methods thereof, and particularly to, an electronic device having a touch screen and an image zooming method for the electronic device.

2. Description of Related Art

Electronic devices with touch screens, e.g., mobile phones, digital photo frames, electronic readers (e-reader), are capable of zooming the image displayed on the touch screen by manipulating the touch screen. For example, for zooming out the displayed image, the user uses two fingers sliding towards each other, and for zooming in the displayed image, the user uses two fingers sliding away from each other. However, both two fingers slide when applying the zooming method, which cannot satisfy various demands of different users.

Therefore, what is needed is an electronic device and an image zooming method thereof to alleviate the limitations described above.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding sections throughout the several views.

FIG. 1 is a block diagram of an electronic device in accordance with an exemplary embodiment.

FIG. 2 is a schematic diagram of the electronic device of FIG. 1.

FIG. 3 is a flowchart of an image zooming method for electronic devices, such as the one of FIG. 1, in accordance with the exemplary embodiments.

### DETAILED DESCRIPTION

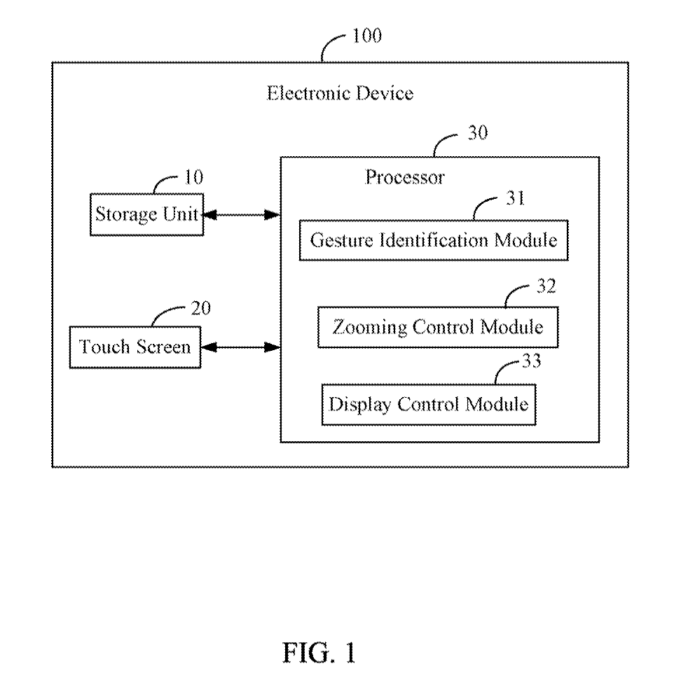

FIG. 1 is an exemplary embodiment of a disclosure of an electronic device 100. The electronic device 100 can conveniently zoom the displayed image in or out in response to a touch operation. The electronic device 100 is an electronic reader having a touch screen. In alternative embodiments, the electronic device 100 can be other electronic devices having touch screens, such as a mobile phone, a tablet, a digital phone frame or the like.

The electronic device 100 includes a storage unit 10, a touch screen 20, and a processor 30. The storage unit 10 stores a plurality of electronic files. The electronic file includes pictures, and/or photos etc. The touch screen 20 is configured for generating operation signals in response to a touch operation. For example, the user can operate the touch screen to open an electronic file, flip pages, zooming a displayed image in or out, select a page, or drag a page for example.

The processor 30 includes a gesture identification module 31, a zooming control module 32, and a display control module 33.

In the embodiment, when the electronic device 100 is activated, the touch screen 20 displays an image selected by a user. The electronic device 100 automatically enters a zooming mode when the image selected by the user is displayed on the touch screen 20. In an alternative embodiment, when the image selected by the user is displayed on the touch screen 20, the electronic device 100 will not automatically enter the zooming mode, instead, the user can operate a zooming icon from a menu displayed on the touch screen 20. The electronic device 100 then enters the zooming mode.

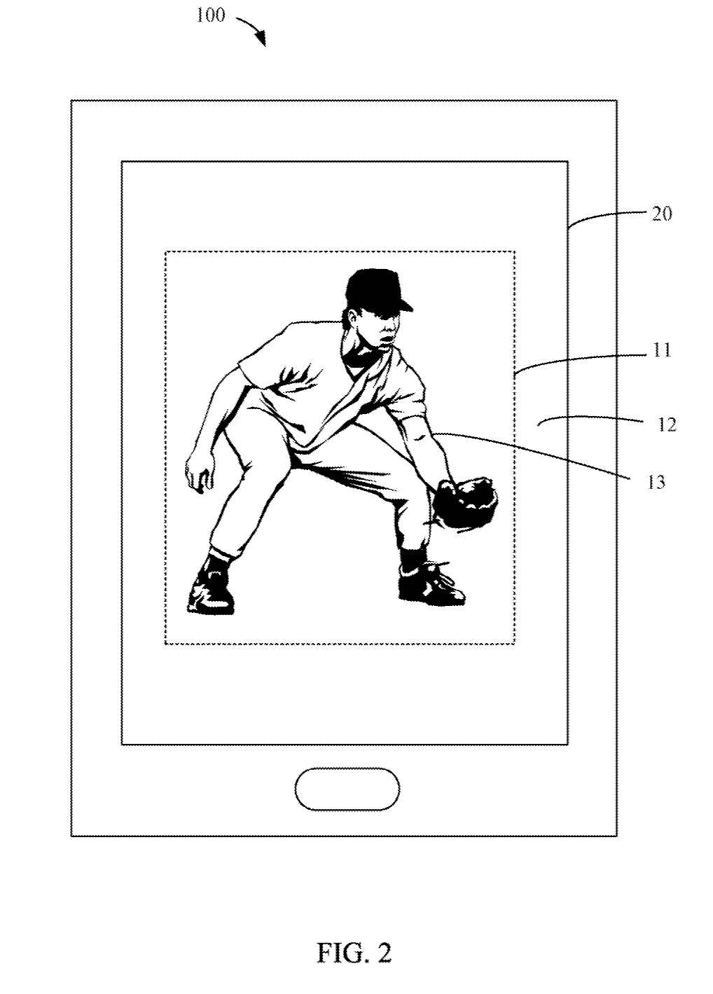

FIG. 2 shows a page is displayed on the touch screen 20. The page includes an image region 11 and a non-image-displaying region 12. The image region 11 is the region where an image 13 is displayed. The image region 11 is the region circled by the rectangular frame in dotted line displayed on the touch screen 20 of FIG. 2. The non-image-displaying region 12 is the remaining region of the touch screen 20 where no image is displayed. That is, the non-image-displaying region 12 is the region of the touch screen 20 that excludes the image region 11. The non-image-displaying region 12 is used for displaying icons for operation, the information of the displayed image, etc. In an alternative embodiment, the displayed page can also include characters and/or figures, for example. If a zooming gesture is applied on the page 11, the page 11 will be zoomed accordingly. Then, the user can zoom the image 13 in or out by applying a zooming gesture on the image region 11 or the non-image-displaying region 12.

In the embodiment, the image 13 is selected from the group consisting of: a photo, a picture, and other images having the .tif format, .jpg format, or .pdf format etc.

The gesture identification module 31 is configured for identifying the touch operation according to the operation signals generated by the touch screen 20 in response to a touch operation. The gesture identification module 31 is also configured for determining whether the identified touch operation is an image zooming gesture, and determining the type of the image zooming gesture if the identified touch operation is an image zooming gesture. The gesture identification module 31 also transmits the identified and determined results to the zooming control module 32.

In the embodiment, when the gesture identification module 31 identifies a page including an image 13 is displayed on the touch screen 20, and a click operation is applied on the touch screen 20, the gesture identification module 31 determines the identified touch operation is an image zooming gesture. The gesture identification module 31 continues to determine a touch region of the touch screen 20 that the click operation been applied on and determines the type of the image zooming gesture according to the determined touch region of the click operation. The type of the image zooming gestures includes the zooming in gesture and the zooming out gesture. In an alternative embodiment, when the gesture identification module 31 identifies a page including an image 13 is displayed on the touch screen 20, and a slide operation is applied on the touch screen 20, the gesture identification module 31 determines the identified touch operation is an image zooming gesture. In other words, the touch operation applied on the touch screen 20 for zooming the image 13 displayed thereon can be predefined according to actual need.

In a first embodiment, when the gesture identification module 31 determines that a touch operation of the user is a click operation and is applied on the image region 11 of the touch screen 20, the gesture identification module 31 determines the touch operation is an image zooming in gesture for zooming in the displayed image 13. When the gesture identification module 31 identifies that a touch operation of the user is a click operation and is applied on the non-image-displaying region 12 of the touch screen 20, the gesture identification module 31 determines the touch operation is an image zooming out gesture for zooming out the displayed image 13.

In a second embodiment, when the gesture identification module 31 determines that a touch operation of the user is a click operation and is applied on the image region 11 of the touch screen 20, the gesture identification module 31 determines the touch operation is an image zooming out gesture for zooming out the displayed image 13. When the gesture identification module 31 identifies that a touch operation of the user is a click operation and is applied on the non-image-displaying region 12 of the touch screen 20, the gesture identification module 31 determines the touch operation is an image zooming in gesture for zooming in the displayed image 13.

The zooming control module 32 is configured to create a zoomed image according to the displayed image, a predetermined zooming ratio and the type of the image zooming gesture. In the embodiment, if the gesture identification module 31 identifies the touch operation is a zooming in gesture, the zooming control module 32 creates a zoomed image which is zoomed in with the predetermined zooming ratio relative to the current image displayed on the touch screen 20. If the gesture identification module 31 identifies the touch operation is a zooming out gesture, the zooming control module 32 creates a zoomed image which is zoomed out with the predetermined zooming ratio relative to the current image displayed on the touch screen 20.

In the embodiment, the predetermined zooming ratio is 10%. In other embodiments, the predetermined zooming ratio can be 20%, 30%, or 50%, for example.

The display control module 33 controls to display the zoomed image created by the zooming control module 32 on the touch screen 20. In the embodiment, once a click operation is applied on the touch screen 20, the zooming control module 32 creates a zoomed image which is zoomed in/out with the predetermined zooming ratio (eg. 10%) relative to the current image displayed on the touch screen 20. The display control module 33 controls to display the zoomed image on the touch screen 20. The zooming control module 32 creates real-time zoomed image in response to the user's zooming gesture. In an alternative embodiment, the zooming control module 32 creates a zoomed image when the user's zooming gesture is over, eg. the user may apply click operations on the touch screen 20 more than one time within a predetermined time period, thus to zoom the image with the predetermined zooming ratio for more than one time.

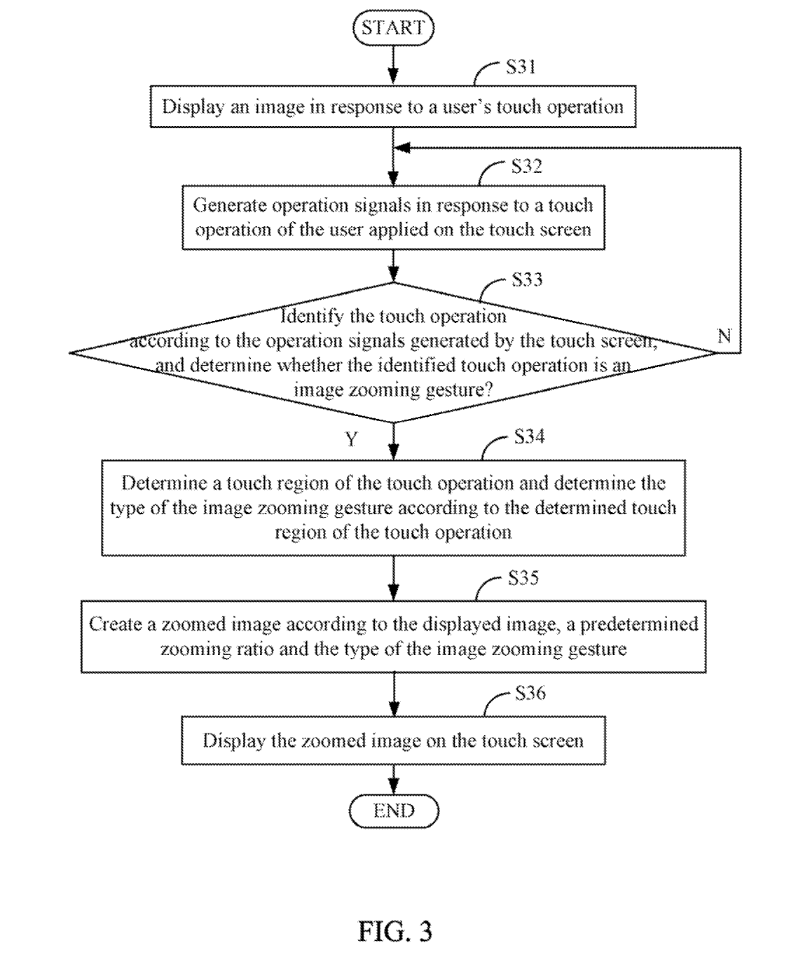

FIG. 3 shows a flowchart of an image zooming method of the electronic device 100 of FIG. 1. The electronic device 100 includes a touch screen. The touch screen is configured for generating operation signals in response to touch operations. The method includes the following steps, each of which is related to the various components contained in the electronic device 100.

In step S31, the touch screen 20 displays an image in response to a user's touch operation.

In step S32, the touch screen 20 generates operation signals in response to a touch operation of the user applied on the touch screen 20.

In step S33, the gesture identification module 31 identifies the touch operation according to the operation signals generated by the touch screen 20, and determines whether the identified touch operation is an image zooming gesture. If yes, the process goes to step S34, otherwise, the process goes back to step S32. In the embodiment, when the gesture identification module 31 identifies a page including an image 13 displayed on the touch screen 20, and a click operation or a slide operation applied on the touch screen 20, the gesture identification module 31 determines the identified touch operation is an image zooming gesture.

In step S34, the gesture identification module 31 determines a touch region of the touch operation and determines the type of the image zooming gesture according to the determined touch region of the touch operation. The type of the image zooming gestures includes the zooming in gesture and the zooming out gesture. The touch region includes the image region 11 and the non-image-displaying region 12. The gesture identification module 31 also transmits the determined results to the zooming control module 32.

In step S35, the zooming control module 32 creates a zoomed image according to the displayed image, a predetermined zooming ratio and the type of the image zooming gesture. In the embodiment, if the gesture identification module 31 identifies the touch operation is a zooming in gesture, the zooming control module 32 creates a zoomed image which is zoomed in with the predetermined zooming ratio relative to the current image displayed on the touch screen 20. If the gesture identification module 31 identifies the touch operation is a zooming out gesture, the zooming control module 32 creates a zoomed image which is zoomed out with the predetermined zooming ratio relative to the current image displayed on the touch screen 20.

In step S36, the display control module 33 controls to display the zoomed image created by the zooming control module 32 on the touch screen 20.

With such a configuration, when a user wants to zoom in or zoom out the image displayed on the touch screen 20, the user can use one finger click on the image region 11 or the non-image-displaying region 12, then, the displayed image is zoomed in or zoomed out accordingly and the zoomed page is displayed on the touch screen 20. The user can conveniently control to zoom in or zoom out the displayed image on the touch screen 20 by clicking on the image region 11 or the non-image-displaying region 12, and can dynamically control the zooming ratio (the size of the zoomed image) by controlling the operation times of the click operation on a same region of the touch screen 20.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An image zooming method for an electronic device having a touch screen, the method comprising:
displaying an image on the touch screen;
generating operation signals in response to a user's touch operation applied on the touch screen when the touch screen displays the image;
determining a touch region of the touch operation, so as to determine the touch operation as a type of an image zooming gesture according to the determined touch region, the type of the image zooming gesture being selected from a group consisting of a zooming in gesture and a zooming out gesture;
creating a zoomed image according to the displayed image, a predetermined zooming ratio and the determined type of the image zooming gesture; and
displaying the zoomed image on the touch screen.

2. The method as described in claim 1, wherein the touch operation is selected from the group consisting of: a click operation, and a slide operation.

3. The method as described in claim 1, wherein the step “determining a touch region of the touch operation, so as to determine the touch operation as a type of an image zooming gesture according to the determined touch region” comprises:
determining whether a touch region of the touch operation is an image region, if the touch operation is applied on the image region of the touch screen where the image is displayed; determining the touch operation as the zooming in gesture; and
determining whether a touch region of the touch operation is a non-image-displaying region, if the touch operation is applied on the non-image-displaying region of the touch screen where no image is displayed; determining the touch operation as the zooming out gesture.

4. The method as described in claim 1, wherein the step “determining a touch region of the touch operation, so as to determine the touch operation as a type of an image zooming gesture according to the determined touch region” comprises:
determining whether a touch region of the touch operation is an image region, if the touch operation is applied on the image region of the touch screen where the image is displayed; determining the touch operation as the zooming out gesture; and
determining whether a touch region of the touch operation is a non-image-displaying region, if the touch operation is applied on the non-image-displaying region where no image is displayed; determining the touch operation as the zooming in gesture.

5. The method as described in claim 1, wherein the step “creating a zoomed image according to the displayed image, a predetermined zooming ratio and the determined type of the image zooming gesture” comprises:
creating a zoomed image which is zoomed in with the predetermined zooming ratio relative to the displayed image, if the determined type of the image zooming gesture is the zooming in gesture; and
creating a zoomed image which is zoomed out with the predetermined zooming ratio relative to the displayed image, if the determined type of the image zooming gesture is the zooming out gesture.

6. The method as described in claim 1, wherein the predetermined zooming ratio is selected from the group consisting of: 10%, 20%, 30%, and 50%.

7. An electronic device, comprising:
a touch screen, configured for generating operation signals in response to a user's touch operation applied on the touch screen when the touch screen displays the image; and
a processor comprising:
a gesture identification module, configured for determining a touch region of the touch operation, so as to determine the touch operation as a type of an image zooming gesture according to the determined touch region, the type of the image zooming gesture being selected from a group consisting of a zooming in gesture and a zooming out gesture;
a zooming control module, configured for creating a zoomed image according to the displayed image, a predetermined zooming ratio and the determined type of the image zooming gesture; and
a display control module, configured for displaying the image and the zoomed image on the touch screen.

8. The electronic device as described in claim 7, wherein the touch operation is selected from the group consisting of: a click operation, and a slide operation.

9. The electronic device as described in claim 7, wherein if the touch operation is applied on an image region of the touch screen where the image is displayed, the gesture identification module determines that the type of the image zooming gesture is a zooming in gesture, and if the touch operation is applied on a non-image-displaying region of the touch screen where no image is displayed, the gesture identification module determines that the type of the image zooming gesture is a zooming out gesture.

10. The electronic device as described in claim 7, wherein if the touch operation is applied on an image region of the touch screen where the image is displayed, the gesture identification module determines that the type of the image zooming gesture is a zooming out gesture, and if the touch operation is applied on a non-image-displaying region of the touch screen where no image is displayed, the gesture identification module determines that the type of the image zooming gesture is a zooming in gesture.

11. The electronic device as described in claim 7, wherein if the determined type of the image zooming gesture is the zooming in gesture, the zooming control module creates a zoomed image which is zoomed in with the predetermined zooming ratio relative to the displayed image, and if the determined type of the image zooming gesture is the zooming out gesture, the zooming control module creates a zoomed image which is zoomed out with the predetermined zooming ratio relative to the displayed image.

12. The electronic device as described in claim 6, wherein the predetermined zooming ratio is selected from the group consisting of: 10%, 20%, 30%, and 50%.
